(19) United States
(12) Patent Application Publication
(10) Pub. No.: US 2007/0110379 A1
(43) Pub. Date: May 17, 2007

(54) Pinch waveguide

(75) Inventors: Lawrence C. West, San Jose, CA (US); Gregory L. Wojcik, Ben Lomond, CA (US)

Correspondence Address: WILMER CUTLER PICKERING HALE AND DORR LLP, 60 STATE STREET, BOSTON, MA, 02109, US

(73) Assignee: Applied Materials, Inc. Legal Department, Santa Clara, CA (US)

(21) Appl. No.: 11/599,192

(22) Filed: Nov. 14, 2006

Related U.S. Application Data
(60) Provisional application No. 60/736,202, filed on Nov. 14, 2005.
(60) Provisional application No. 60/736,201, filed on Nov. 14, 2005.

(51) Int. Cl. G02B 6/10

(52) U.S. Cl. 385/129; 385/131; 385/132

(57) ABSTRACT

A waveguide is provided including a first photon propagating material having a first index of refraction (n1) and having a pinch disposed therein, the pinch having a second index of refraction (n1′); and a second photon propagating material disposed in optical communication with the first photon propagating material and having a third index of refraction (n2); wherein n1<n1, n1′<n2, and the pinch redirects at least a portion of the photons from the first photon propagating material to the second photon propagating material.

This application claims the benefit of U.S. Provisional Patent Application No. 60/736,202, entitled “Pinch Waveguide” filed on Nov. 14, 2005.

### CROSS-REFERENCE TO RELATED APPLICATIONS

This application makes reference to co-pending U.S. Provisional Patent Application No. 60/736,480, entitled “Semiconductor Device Having A Laterally Injected Active Region” filed on Nov. 14, 2005, and U.S. Provisional Patent Application No. 60/736,201, entitled “Semiconductor Laser” filed on Nov. 14, 2005, the contents of both of which are incorporated herein by reference.

### BACKGROUND OF THE INVENTION

1. Field of the Invention

The present invention relates generally to optical waveguides, and more particularly to an optical waveguide that changes the depth of propagation of the photons in the waveguide.

2. Description of the Prior Art

Optoelectronic integrated circuits (OEICs) have found significant applications in a number of fields including communications and optical interconnects of computing. However, those concerned with designing OEICs have recognized the meed for developing improved optical interconnects capable of transmitting light between active devices that form these integrated circuits. Conventional OEICs usually employ optical waveguides as device interconnects. Specifically, circuit fabricators have used thin films of various materials to form optical waveguides directly on the surface of OEIC structures.

Typically, active devices or electronic logic elements such as those employed in electronic computer systems do not directly interface with optical information processing and communications systems. Therefore, in a typical system interface involving both electronic and optical techniques, photons must be detected and converted to electrical energy of commensurate signal information, the signal processing operations must then be performed electronically, and that procedure followed by reconversion of the electrical signals to photons.

Various techniques and fabrication methods have been utilized to construct OEICs that provide control over the in plane direction of the path of photons in an OEIC. For example, waveguide bends, waveguide junctions and directional couplers have been used to assist in controlling the direction of the path of the photons; however, often the current methods are difficult or expensive to fabricate and often result in optical loss or leakage. In addition, these devices do not address out of plane or the depth of optical coupling.

### SUMMARY OF THE INVENTION

Embodiments described herein include a waveguide that will redirect photons propagating in the waveguide in a direction substantially perpendicular to the propagation axis of the waveguide.

Various embodiments also provide for inter-planar propagation of a wave front disposed in a waveguide and allow control over the amount of photons directed to select regions of an OEIC.

In general, in one aspect, the invention features a waveguide including: a first photon propagating material having a first index of refraction (n1) and having a pinch disposed therein, the pinch having a second index of refraction (n1′); and a second photon propagating material disposed in optical communication with the first photon propagating material and having a third index of refraction (n2); wherein n1′<n1, n1′<n2, and the pinch redirects at least a portion of the photons from the first photon propagating material to the second photon propagating material.

In general, in another aspect, the invention features an optical apparatus including: a first photon propagating material having a first index of refraction (n1) and having a pinch disposed therein, the pinch having a second index of refraction (n1′); and a second photon propagating material disposed in optical communication with the first photon propagating material and the second photon propagating material having a target region disposed therein and the target region having a third index of refraction (n2); wherein n1′<n1, n1′<n2, and the pinch redirects at least a portion of the photons from the first photon propagating material to the second photon propagating material in at least the target region.

In general, in still another aspect, the invention features an optical apparatus including: a first photon propagating material having a first index of refraction (n1) and having a pinch disposed therein, the pinch having a second index of refraction (n1′); a second photon propagating material disposed in direct contact with the first photon propagating material and the second photon propagating material having a target region disposed therein and the target region having a third index of refraction (n2); and a photon source for supplying photons to the first photon propagating material; wherein n1′<n1, n1′<n2, and the pinch redirects at least a portion of the photons from the first photon propagating material to the second photon propagating material in at least the target region.

In general, in still yet another aspect, the invention features a waveguide including: a first photon propagating material having a first index of refraction (n1) and having a first pinch disposed therein, the pinch having a second index of refraction (n1′); and a second photon propagating material disposed in direct contact with the first photon propagating material and having a third index of refraction (n2), the second photon propagating material having a second pinch oriented opposite that of the first pinch in an axial direction; wherein n1′<n1, n1′<n2, and the first and second pinches redirect at least a portion of the photons from the first photon propagating material to the second photon propagating material.

Other objects and features of the invention will be apparent from the following detailed description.

### BRIEF DESCRIPTION OF THE DRAWINGS

The invention will be described in conjunction with the accompanying drawings, in which:

FIG. 1A is a top view of a waveguide embodying aspects of the invention.

FIG. 1B is a side view of the waveguide of FIG. 1A.

FIG. 2 is a schematic cross-sectional view of a waveguide embodying various aspects of the invention and showing the path of photon propagation.

FIG. 3 is a schematic cross-sectional view of a waveguide coupled with a light source and showing the path of photon propagation.

FIG. 4 is a schematic cross-sectional view of a waveguide showing the path of photon propagation.

FIG. 5 is a top perspective view of a cross-section of another waveguide embodying various aspects of the invention.

FIG. 6A is a top perspective view of another waveguide embodying various aspects of the invention.

FIGS. 6B, 6C and 6D are cross-sections of the waveguide illustrated in FIG. 6a which illustrate the optical confinement of the wavefront in the waveguide.

FIGS. 7, 8, 9, 10, 11, 12 and 13 are schematic representations of top views of different waveguides embodying aspects of the present invention.

FIG. 14 is a schematic cross-sectional side view of a waveguide embodying various aspects of the present invention.

FIGS. 15A, 15B and 15C are cross-sectional end views of waveguides embodying various aspects of the present invention.

FIGS. 16A, 16B, 16C and 16D are cross-sectional end views of waveguides embodying various aspects of the present invention.

### DETAILED DESCRIPTION OF THE PREFERRED EMBODIMENT

A waveguide is provided, comprising a first photon propagating material having a first index of refraction (n1) and having a pinch disposed therein, the pinch having a second index of refraction (n1′); and a second photon propagating material disposed in optical communication with the first photon propagating material and having a third index of refraction (n2); wherein n1′<n1, n1′<n2, and the pinch redirects at least a portion of the photons from the first photon propagating material to the second photon propagating material.

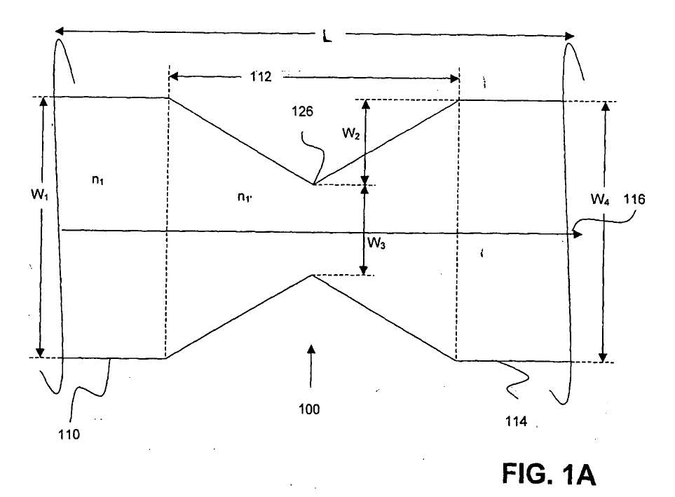

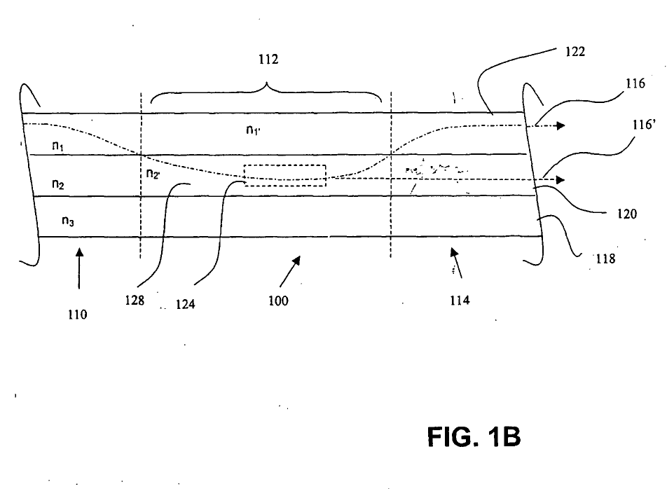

Turning now to FIG. 1

IA, a top view of a waveguide 100 is illustrated. As may be seen, waveguide 100 has three distinct regions. The first region is an upstream region 110. Next is a pinch region 112. Finally, there is a downstream region 114. It should be appreciated that the terms upstream and downstream are utilized to provide axial location with respect to pinch region 112 in the direction of the propagation of light 116 as illustrated by the associated line. As may be seen, waveguide 100 has an axial length L. In the described embodiment, L will be about 20 micrometers or less. The selection of the length L is non-trivial in that prior art inter-planar couplers are on the order of 100 micrometers or more. Thus, prior art waveguides can be a factor of 10 times larger than the currently described embodiment. It should also be understood that waveguides having a length of greater than 20 micrometers are within the scope of the teachings of the present invention.

Waveguide 100 has a lateral width of W₁. In the described embodiment, width W₁ of waveguide 100 is some fraction of the wavelength of light 116 propagating through waveguide 100. Generally, width W₁ would be defined by the equation: W₁≦λ2, where λ is the free space wavelength of light 116 propagating within waveguide 100. In the described embodiment, W₁ is less than or equal to ½ a micrometer, when λ=1.5 μm. The selection of width W₁ is non-trivial in that prior art waveguides have widths that are on the order of 2λ or greater. Thus, prior art waveguides can be a factor of 4 times wider than the currently described embodiment. It should be appreciated that waveguides 100 having a width of greater than λ/2 are within the scope of the teachings of the present invention.

Turning now to FIG. 1B, a side view of waveguide 100 is illustrated. As may be seen, waveguide 100 comprises at least three layers. The first layer is an optional substrate 118. In the described embodiment, substrate 118 is glass (SiO₂). However, substrate 118 could be formed from a uniform layer of III-V, IV, and/or II-VI semiconductor material selected from the group comprising: GaAs, InP, AlAs, etc, or any combination thereof. In an embodiment in which substrate 118 is at least partially optically transparent it can be made of indium phosphide (InP). In general, the index of refraction (n₃) for substrate 118 will be between 1.4 and 3.5 and it will be between 3.18 and 3.41 when InP is utilized, depending on λ. The material utilized in substrate 118 is selected to provide lattice matching with interaction layer 120. If it is desired to utilize waveguide 100 in an active device, then n₃ will be at an upper portion of the range identified above. If it is desired to utilize waveguide 100 in a passive device, then n₃ will be at a lower portion of the range identified above. It should be appreciated that substrate 118 may be non-uniform with respect to the index of refraction in an axial, lateral, and/or transverse direction. For example, the index of refraction for substrate 118 may be different in regions 110, 112, and/or 114. For simplicity, we will refer to substrate 118 having an index of refraction n₃, whether it is uniform or if that is the average or index of refraction for substrate 118.

Disposed above substrate 118 is an interaction layer 120. In the described embodiment, interaction layer 120 is formed from a uniform layer of III-V, IV, and/or II-VI semiconductor material selected from the group comprising: GaAs, InP, AlAs, etc., or any combination thereof. A portion of interaction layer 120 could comprise an active material and have an active region 124 disposed in target region 128. It should be appreciated that target region will have an index of refraction n₂′ which is different than layer 120 outside of target region 128, i.e., have an index of refraction n₂. Typically, n₂′>n₂. In some embodiments, interaction layer 120 will be at least partially optically transparent. The index of refraction (n₂′) for target region 128 will be between 3.4 and 3.6 (e.g. 3.5) while n₂ for interaction layer 120 will be between 1 and 3.4. It should be appreciated that interaction layer 120 may be non-uniform with respect to the index of refraction in an axial, lateral, and/or transverse direction outside of target region 128. For example, the index of refraction for interaction layer 120 may be different in regions 110, 112, and/or 114. While no intermediate layers are illustrated between substrate 118 and interaction layer 120, it should be appreciated that the presence or absence of these intermediate layers are within the scope of the teachings of the present invention.

It is also contemplated that in various embodiments interaction layer 120 will comprise distinct sub-layers which may or may not be constructed from the same material. It should be appreciated that interaction layer 120 may be non-uniform with respect to the index of refraction in an axial, lateral, and/or transverse direction. For example, the index of refraction for interaction layer 120 may be different in regions 110, 112, 114, and/or 128. For simplicity, we will refer to interaction layer 120 having an index of refraction n₂, whether it is uniform or if that is the average or index of refraction for interaction layer 120 outside of target region 128.

Disposed above interaction layer 120 is a confinement layer 122. In the described embodiment, confinement layer 122 is formed from a uniform layer of III-V, IV, and/or II-VI semiconductor material selected from the group comprising: Si, GaAs, InP, AlAs, etc., or any combination thereof. In at least some embodiments, confinement layer 122 will at least partially optically transparent. It should be appreciated that confinement layer 122 may be multimode or single mode. In the described embodiment, the index of refraction (n₁) for confinement layer 122 will be between 3.4 and 3.6 (e.g. 3.49). It should be appreciated that confinement layer 122 may be non-uniform with respect to the index of refraction in an axial, lateral, and/or transverse direction. For example, the index of refraction for confinement layer 122 may be axially different in regions 110, 112, and/or 114 as well as laterally different within any of the regions 110, 112, and/or 114. For simplicity, we will refer to confinement layer 122 having an index of refraction n₁, whether it is uniform or if that is the average index of refraction for confinement layer 122 in regions 110 and 114. Confinement layer 122 has an index of refraction n₁′, whether it is uniform or if that is the average index of refraction for confinement layer 122 in region 112. While no intermediate layers are illustrated between interaction layer 120 and confinement layer 122, it should be appreciated that the presence or absence of these intermediate layers are within the scope of the teachings of the present invention.

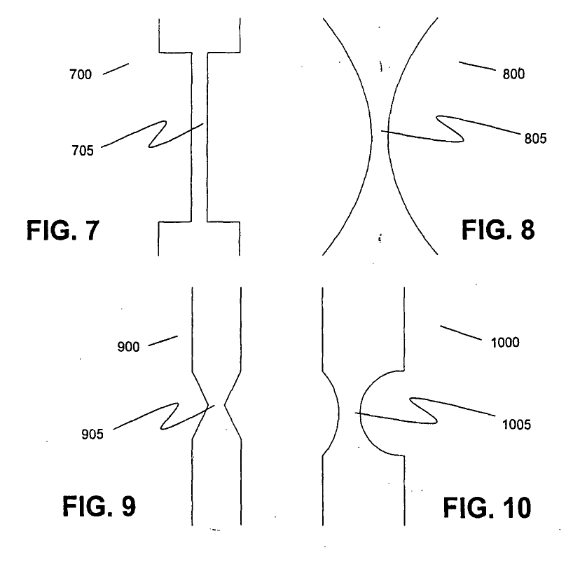

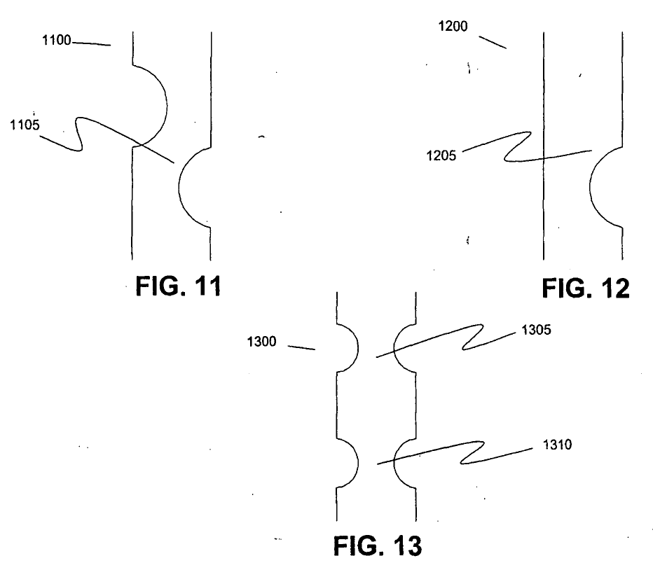

Pinch region 112 is illustrated as tapering or “pinching” from a width W₁ to a width W₃ and then expanding to a width W₄. In the described embodiment, the change in pinch region 112 is uniform and symmetrical. A goal of designing pinch region 112 is to eliminate as many discontinuities as possible and to remove any sharp corners that may adversely effect wave propagation. In the described embodiment, the change in width is also smooth, i.e., the first derivative would be a continuous as illustrated in the numerous embodiments in the figures. The specific goal of the pinch is to reduce waveguide 100 to a width W₃. Typically, W₃ is be small enough to prevent any modes from existing downstream of the narrowest point 126 of pinch region 112. Thus, W₃ is between 0 and W₁, depending on the particular wavefront propagating in waveguide 100. It should be appreciated that pinch region 112 may have any shape, such as a quadric, cosine, polynomial series, and/or any other shape specifically illustrated in FIGS. 7 through 13. While these Figures illustrate specific shapes, these shapes are merely illustrative. In the described embodiment, the index of refraction n₁′<n₁ and n₁′<n₂; in addition, n₁′<n₂¹′.

Pinch region 112 is illustrated as expanding from a width W₃ to a width W₄, downstream of point 126. It should be appreciated that width W₄ may be greater than W₁ or may be less than W₃, i.e., pinch region 112, downstream of point 126, may either expand or contract further, depending on the specific downstream result required in region 114. We will now discuss the specific widths for downstream region 114 with respect to the width W₄, in the table, below.

| Relationship of W₄ | Downstream Effect in Region 114 |
|---|---|
| W₄ = 0 | No mode will propagate in layer 122, mode |
| | will propagate in layer 120. |
| W₄ ≦ W₃ | No mode will propagate in layer 122, |
| | mode will propagate in layer 120. |
| W₃ < W₄ ≦ W₁ | Mode will propagate in layer 122, |
| | mode may propagate in layer |
| | 120. If there are two modes in |
| | waveguide 100, one mode may |
| | propagate in layer 122 and the other |
| | mode may propagate in layer 120. |
| W₁ ≦ W₄ | Mode will propagate in layer 122. |

It should be appreciated that while pinch region 112 has been illustrated as a two dimensional taper, it may in fact, be desirable to have pinch region 112, upstream of point 126, taper in three dimensions, i.e. provide a change in n_{1′} in the axial, lateral and transverse directions.

Waveguide 100 may be maintained in free space or may be enclosed in a protective material such as glass (SiO₂). The enclosing material or free space will have an effective index of refraction of n₀. In the described embodiment, n₁ is greater than n₀, e.g. n₁ is 2 times greater than n₀.

While FIG. 1B illustrates waveguide 100 as having substrate 118, it should be appreciated that substrate 118 may be removed. In the event of removing substrate 118, the protective material may be treated as the substrate. If substrate 118 is not optically transparent, then it may be desirable to remove substrate 118. This may be accomplished by mechanical polishing, chemical etching, and/or cleaving, or any other method known in the semiconductor material processing art.

It should be appreciated that while light 116 is illustrated as penetrating “down” into interaction layer 120 which is disposed below confinement layer 122, it may be advantageous to have light propagate “up” above confinement layer 122. To accomplish this, one would have to assure that in some region above confinement layer 122, the index of refraction for that region would be greater than n₁′.

While it has been illustrated that regions 112 are in axial alignment, it should be appreciated that the alignment of region 112 in layer 118 is not critical. The alignment of region 112 in layers 120 and 122 has some criticality in that region 112 in layer 122 should have some overlap with region 112 in layer 120. In the described embodiment, region 112 in layer 122 would start before region 112 starts in layer 120. Also, typically, region 112 in layer 122 would end after region 112 ends in layer 120. That would assure photon interaction with target region 124.

The relationship of the index of refraction of confinement layer 122 and interaction layer 120 are important in determining the confinement of light 116 to a particular layer 120,122 in regions 110, 112, and 114, i.e., the creation of a low velocity channel for light 116 to propagate in. The following table illustrates this concept.

| | Relation- | Range | |
|---|---|---|---|
| | ship of | of Index | |
| | Index of | Contrast | |
| Region | refraction | ABS(n₁-n₂) | Effect on low velocity channel |
| 110 | n₁ > n₂ | 0.05 to 2.05 | Low velocity channel in confinement |
| | | | layer 122 |
| 110 | n₁≈n₂ | 0.0 to 0.1 | Low velocity channel in confinement |
| | | | layer 122 and interaction layer 120 |
| 110 | n₁ < n₂ | 0.05 to 2.05 | Low velocity channel in interaction |
| | | | layer 120 |
| 112 | n₁′ < n₂′ | 0.05 to 2.5 | Low velocity channel in confinement |
| | | | layer 122 and interaction layer 120 |
| 114 | n₁ < n₂ | 0.05 to 2.05 | Low velocity channel in interaction |
| | | | layer 120 |
| 114 | n₁≈n₂ | 0.05 to 2.05 | Low velocity channel in confinement |
| | | | layer 122 and interaction layer 120 |
| 114 | n₁ > n₂ | 0.05 to 2.05 | Low velocity channel in confinement |
| | | | layer 122 |

Thus, by appropriately designing the width of regions 110, 112, and 114 with the appropriate index relationship, one is able to create a unique set of low velocity channels for light 116 to propagate in waveguide 100. While the above table provide a desired Δ between n₁ and n₂, it should be appreciated that this is illustrative.

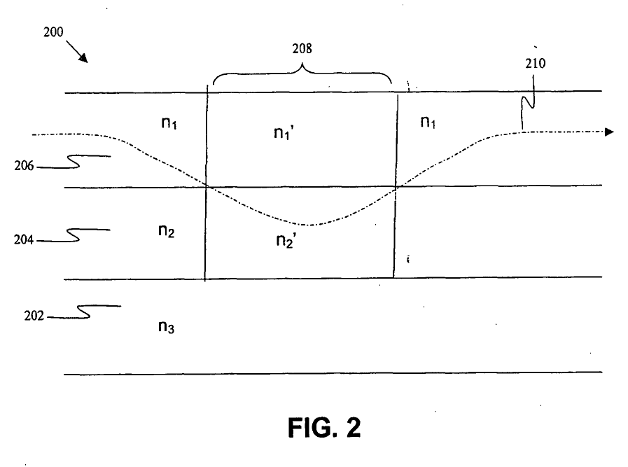

FIG. 2 illustrates the path of photon propagation 210 in a waveguide 200. Waveguide 200 has three layers. An optional substrate 202, an interaction layer 204 and a confinement layer 206. Confinement layer 206 has a region 208 that may comprise a physical pinch or may comprise a material change or alteration to provide a change in the index of refraction along confinement layer 206. Material changes may be accomplished by, but not limited to, the following techniques: ion implantation, material disordering, etching, etching and regrowth, vacancy induced layer disordering, thermal diffusion doping, and/or annealing, etc. In the described embodiment, the indices of refraction defined by regions n₁′ and n₁ have the following relationship n₁′<n₁, where n₁′<n₂. Also, n₁′<n₂′.

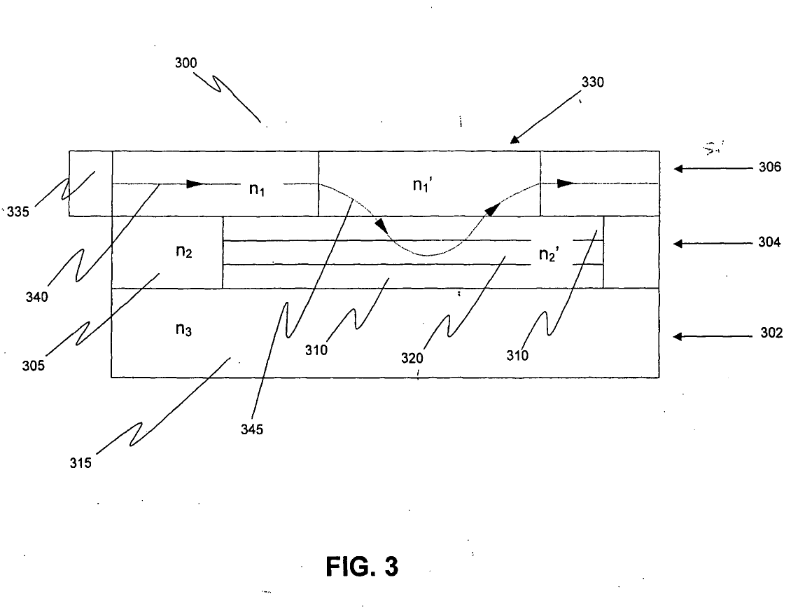

FIG. 3 illustrates the path of photon propagation in another waveguide. Photon source 335 transmits photons into confinement layer 306 as illustrated by photon path 340. Photons propagate along photon path 340 in confinement layer 306. In the described embodiment, confinement layer 306 is made from Si and has an index of refraction of 3.5. When photons reach pinch 330, photons are redirected by pinch 345; which has a lower index of refraction, i.e., between 3.5 and 1.0, to the target region. It should be appreciated that pinch 330 comprises Si and some other material such as SiO₂ or air. In this embodiment, active layer 320 is the target region and has an index of refraction between 3.0 and 3.5. Active layer is formed from InGaAs or InAlGaAs. Because active layer 320 has a higher index of refraction n₂′ compared to dielectric layers 310, photons are efficiently redirected into active layer 320. In addition, insulating regions 305 assists in redirecting photons back into waveguide 300. Typically, insulating regions 305 are formed from SiO2 and have an index of refraction of 1.44. In the described embodiment, substrate 302 is InP.

The photon source may be any suitable source for providing photons to a waveguide, such as a laser, optical fiber, etc. In particular, the teachings herein may be combined with the teachings of U.S. Provisional Patent Application No. (T.B.D.), entitled “Semiconductor Laser” filed on Nov. 14, 2005; or U.S. Provisional Patent Application No. (T.B.D).), entitled “Semiconductor Device Having A Laterally Injected Active Region” filed on Nov. 14, 2005, to allow optical propagation in the active layer or region disclosed in these applications.

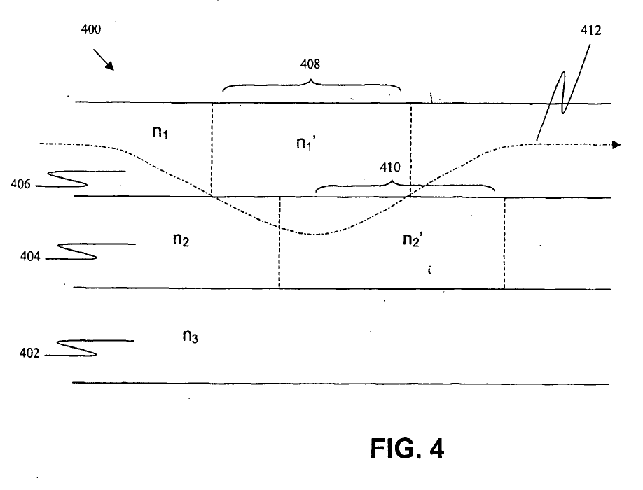

FIG. 4 illustrates the path of photon propagation 412 in another waveguide 400. Waveguide 400 has three layers. An optional substrate 402, an interaction layer 404 and a confinement layer 406. Confinement layer 406 has a region 408 that may comprise a pinch or may comprise a material change or alteration to provide a change in the index of refraction along confinement layer 406. Interaction layer 404 has a region 410 that may comprise a pinch or may comprise a material change or alteration to provide a change in the index of refraction along interaction layer 404. Region 408 starts before region 410 in an axial direction. Because of this relationship, photon propagation path 412 is deflected downward as is approaches region 408. By axially displacing regions 408 and 410, one assures that photon propagation path 412 enters interaction layer 404. As photon propagation path 412 approaches region 410, it begins to rise toward confinement layer 406.

Various specific examples will now be described.

### EXAMPLE I

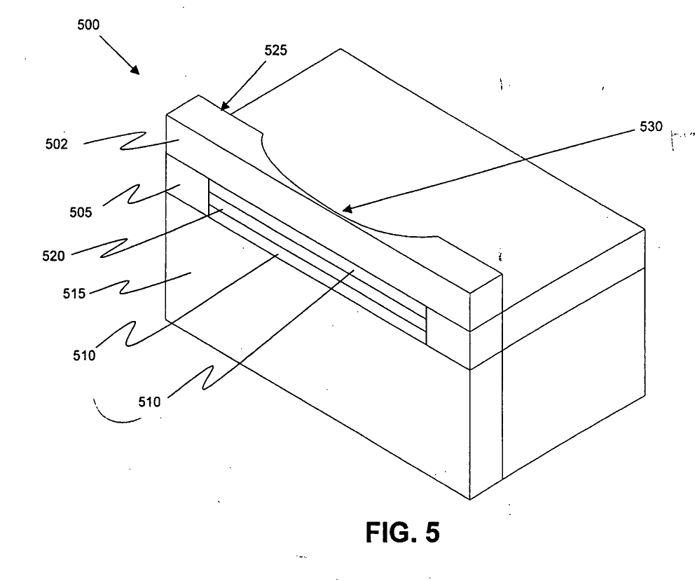

FIG. 5 illustrates a cross-section of a waveguide of the present invention. Waveguide 500 comprises confinement layer 502 present on insulating layer 505, dielectric layers 510 and substrate 515. Between dielectric layers 510 is active layer 520. Confinement layer 502 has a region 525 that has a substantially uniform transverse cross-section. Confinement layer 502 also has a pinch 530 that redirects photons to a target region via the low velocity channel. Photons propagating along the longitudinal axis of waveguide 500 are squeezed together as the photons travel through pinch 530. The effective compression of photons in pinch 530 causes the photons to be directed transversely into a target region (not shown), which is typically into another material or layer having an index of refraction greater than pinch 530.

### EXAMPLE II

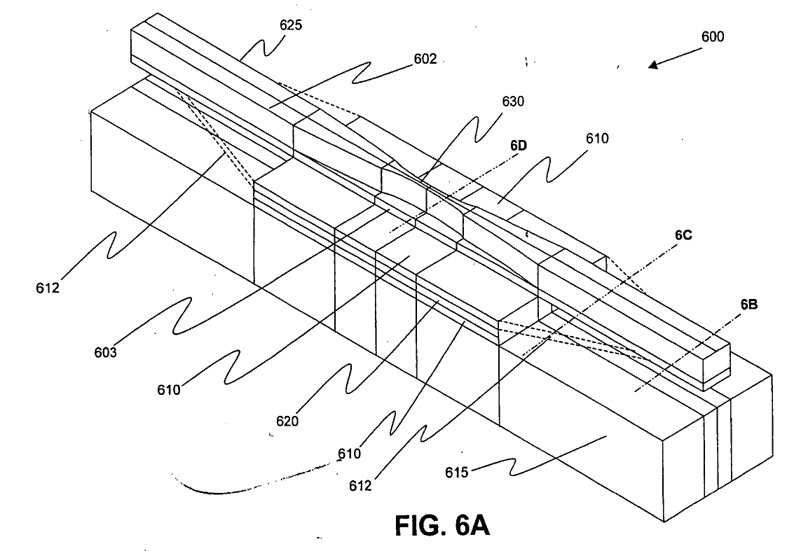

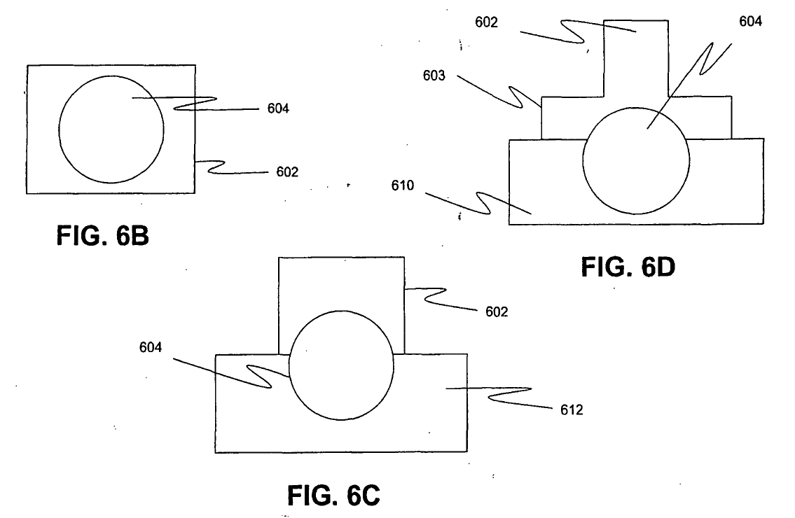

FIGS. 6A, 6B, 6C, and 6D illustrates another waveguide. Waveguide 600 comprises confinement layer 602 disposed directly on top dielectric layer 610 and having substrate 615 disposed below bottom dielectric layer 610. As may be seen, top dielectric layer 610 may have optional pinches 612 and thus form a double dagger with respect to confinement layer 602. Between dielectric layers 610 is active layer 620. Confinement layer 602 has a region 625 that has a substantially uniform transverse cross-section. Confinement layer 602 also has a pinch 630 that redirects photons in a direction of the low velocity channel. It is important to note that section 603 is transverse portion confinement layer 602 which is not pinched in a lateral direction in pinch 630. This is illustrated in FIG. 6D and will be discussed in detail below.

Turning now to FIG. 6D, a description of the photons propagating along the longitudinal axis of waveguide 600 will be described. As may be seen, in FIG. 6B, the photons and respective energy, illustrated by ring 604 is encapsulated by confinement layer 602. As the photons propagate axially down waveguide 600, optional pinch 612 begins to pull the photons into pinch 612 due to the close index of refraction between layers 602 and 610. While pinch 612 is illustrated as being as wide (at its widest point) as layer 610, it should be appreciated that pinch 612 may be as wide as layer 610 or as narrow as region 625. As may be seen in FIG. 6C, photons and respective energy, illustrated by ring 604 are now disposed both in layer 602 and pinch region 612. It should be appreciated this is direct coupling of the photons between these two layers. This is accomplished by physical contact between the two layers and the close indicies of refraction of these two layers as discussed above, i.e., both layers are part of the low velocity channel for some portion of pinch 612. This is in direct contrast to prior art devices that utilize evanescent waves to couple two waveguides such as in the case of delta/beta couplers. Evanescence relies on the coupling of the non-propagating or static optical field disposed outside of the waveguides. Other prior art devices which use evanescence include those taught by Takeuchi et al. in the article entitled “A high-power and high-efficiency photodiode with an evanescently coupled graded-index waveguide for 40 Gb/s applications” and Demiguel et al. in an article entitled “Low-cost, polarization insensitive photodiodes integrating spot size converters for 40 Gb/s applications.” Direct coupling and evanescence are two discrete concepts that are distinctly different in approach and application.

As the photons continue to propagate axially down waveguide 600, pinch 630 begins to push the photons into layer 610 due to the indicies of refraction between layers 630 and 610. As may be seen in FIG. 6D, photons and respective energy, illustrated by ring 604 are now disposed both in layer 610 and section 603. Not all photons are redirected due to interaction with a pinch. Some photons continue to propagate along the longitudinal axis of waveguide 600 in section 603. By not providing a taper in section 603 an unexpected result is achieved with regard to lateral confinement of the photons. By this, we mean that the photons are strongly laterally confined as they propagate axially. This is illustrated by ring 604. This is a highly desired result which prevents optical spread of the beam in a lateral direction.

Photons may be made to contact a laser diode either by redirecting photons from a waveguide via interaction with a pinch, or by directing photons that continue to propagate along the longitudinal axis of the waveguide in region 603 into a laser diode or photon source. When contacting the laser diode or photon source, the photons are at or below a threshold level such that the photons will not cause the laser diode or photon source to lase. However, contacting a laser diode or photon source with this level of photons greatly decreases the amount of time necessary for the laser diode or photon source to overcome the threshold such that the laser diode or photon source will lase. Thus, by controlling the level of photons contacting the laser diode or photon source, the laser diode or photon source may be maintained in a state of readiness.

A double pinch can be used to control the level of photons entering a laser diode. A top view of an exemplary double pinch arrangement is shown in FIG. 10. Photons interacting with a pinch will be redirected at a degree that is dependent upon the magnitude of the pinch and the difference between the effective indices of refraction. Thus, one of ordinary skill in the art could fabricate a variety of pinch waveguides with pinches of varying magnitudes, thicknesses, and/or materials to meet the requirements of particular applications. In a structure having an axially disposed double pinch waveguide, a controlled and predetermined level of photons is allowed to continue along the longitudinal axis of the waveguide to interact with the second pinch. The same degree of control may be exercised at the second pinch, i.e., managing the photons that are redirected and the photons that continue propagating in the waveguide. The waveguide may be fabricated with any number of pinches in any configuration depending on the desired application.

Photon redirection may also be controlled by methods, such as layer doping and cladding. For example, the waveguide, including the pinch, may be clad with any suitable cladding material, such as glass, silicon oxynitride or a polymer, to confine photons within the waveguide. The various layers of the OEIC may be doped to achieve desired indices of refraction for each layer.

Redirected photons may be directed to any suitable device or layer. For example, photons may be redirected to another waveguide. Redirected photons may also be redirected into a target region. In an embodiment of the present invention, the target region may be active layer 620. The target region or active layer may, for example, contain a photodiode (photon detector) that interacts with photons to produce current or may be a laser (photon source) and thus form an optical amplifier. The target region or active layer may contain a variety of optoelectronic devices, logic devices, etc.

### EXAMPLE III

FIGS. 7, 8, 9, 10, 11, 12 and 13 illustrate exemplary pinch regions of different waveguides. A pinch may be any shape, grade or angle such that photons propagating in the waveguide are forced into a narrow region disrupting the path of photon propagation. Pinch 705 in waveguide 700 is representative of a squared pinch, pinch 805 in waveguide 800 is representative of a curved pinch, and pinch 905 in waveguide 900 is representative of an angled pinch. Irregular pinch 1005 in waveguide 1000 illustrates that a pinch does not have to be uniform. In addition, as illustrated by pinch 1105 in waveguide 1100, a pinch may be axially offset. In other words, the indentations in the waveguide do not have to be directly across from one another, but may be axially offset. Pinch 1205 in waveguide 1200 illustrates that a pinch does not have to be disposed on both sides of a waveguide, but rather may, in particular embodiments, a pinch may be disposed on only one side of a waveguide. Pinch 1305 and pinch 1310 in waveguide 1300 illustrate that a waveguide may contain multiple pinches along the longitudinal axis of the waveguide.

In addition, a pinch may be fabricated in a waveguide in combination with a reduction in the top or upper surface of the waveguide. In other words, a waveguide may be tapered or may contain a vertical or transverse pinch in any shape described above for a lateral pinch. Thus, various combinations of pinches are contemplated within the present invention and may be utilized for various applications by one of ordinary skill in the art based on the present disclosure.

### EXAMPLE IV

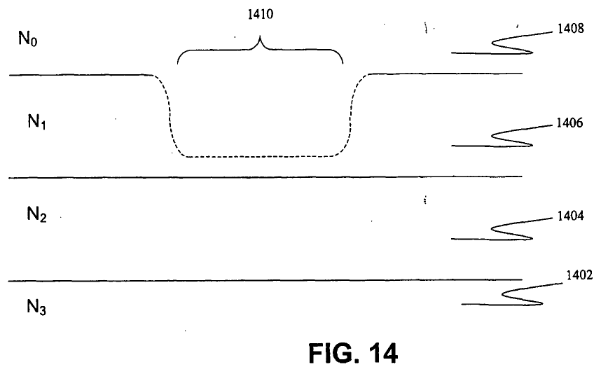

FIG. 14 shows yet another waveguide 1400. Waveguide 1400 has optional substrate layer 1402, interaction layer 1404, and confinement layer 1406. Layer 1408 represents free space or a material encasing waveguide 1400. Region 1410 represents an area from which material has been etched from confinement layer 1406 and thus changing the index of refraction in region 1410 from the rest of layer 1406.

### EXAMPLE V

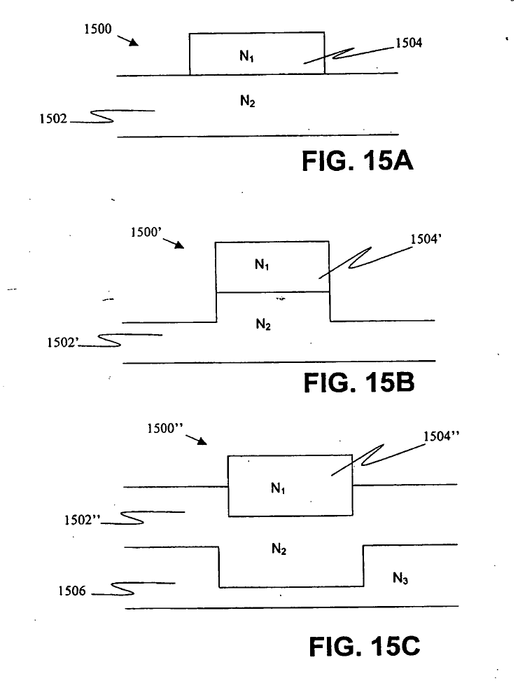

FIGS. 15A, 15B and 15C show cross-sectional views looking down the z-axis of various exemplary waveguides taken in regions 110 and/or 114 of FIG. 1a. In FIGS. 15A, 15B and 15C, layers 1502, 1502′ and 1502″ are sufficiently thin such that these layers are unable to support a mode. FIG. 15A exemplifies a waveguide 1500 in which confinement layer 1504 is present on top of interaction layer 1502. FIG. 15B exemplifies a waveguide 1500′ in which confinement layer 1504′ is raised in a pedestal arrangement on interaction layer 1502′. FIG. 15C exemplifies a waveguide 1500″ that incorporates a substrate layer 1506 and a confinement layer 1504″ that is at least partially embedded in interaction layer 1502″. Interaction layer 1502″ also extends at least partially into substrate layer 1506.

### EXAMPLE VI

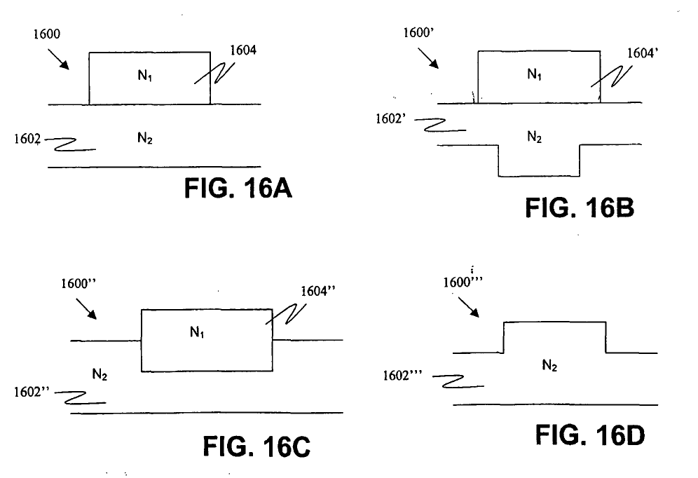

FIGS. 16A, 16b, 16C and 16D show cross-sectional views looking down the z-axis or axially along various exemplary waveguides taken in region 112 of FIG. 1a. In FIGS. 16A, 16b, 16C and 16D, layers 1602, 1602′, 1602″ and 1602′″ are sufficiently thick such that these layers are able to support a mode. FIG. 16A exemplifies a waveguide 1600 in which confinement layer 1604 is present on top of interaction layer 1602. FIG. 16b exemplifies a waveguide 1600′ in which confinement layer 1604′ is present on top of interaction layer 1602′ and interaction layer 1602′ extends downward in the central region beneath confinement layer 1604′. FIG. 16C exemplifies a waveguide 1600″ in which confinement layer 1604″ is at least partially embedded in interaction layer 1602″. FIG. 16D exemplifies a waveguide 1600′″ in which there is no confinement layer, but there is an interaction layer 1602′″ that extends upward.

Waveguides mentioned herein may be of any suitable material. Suitable materials include germanium, silicon, indium-phosphide (InP), gallium-arsenide (GaAs), aluminum-arsenide (AlAs), indium-arsenide (InAs), and/or SiO₂ polymers, etc.

Insulating layers mentioned herein may be of any suitable material. Suitable materials include silicon dioxide (SiO₂) and/or nitrides, etc.

Dielectric layers mentioned herein may be of any suitable material. Suitable materials include SiO₂, Si₃N₄, Al₂O₃, CaF₂, and/or nitrides, etc.

Active layers mentioned herein may be of any suitable material. Suitable materials include, but are not limited to, II-V, IV, and/or II-VI, such as INAlGaAs and InGaAsP.

Suitable materials for substrates mentioned herein include, but are not limited to, III-V, IV, and/or II-VI, such as InP, GaAs, aluminum-gallium-arsenide (AlGaAs), silicon, SiO₂, and sapphire.

Waveguides mentioned herein may be fabricated by any known method. Suitable methods include thin film deposition, dry etching, wet etching, reactive ion etching, epitaxial techniques such as molecular beam epitaxy, lithography such as photolithography and E-beam lithography.

Other suitable fabrication methods and materials are described in U.S. Pat. Nos. 6,051,445; 5,917,967; 5,838,870; 5,559,912; 5,514,885; 5,354,709; 5,163,118; 4,996,575; 4,877,299; and 4,789,642, the entire disclosures of which are hereby incorporated by reference.

Other embodiments are within the following claims.

What is claimed is:

1. A waveguide, comprising:
a first photon propagating material having a first index of refraction (n1) and having a pinch disposed therein, said pinch having a second index of refraction (n1′); and
a second photon propagating material disposed in optical communication with said first photon propagating material and having a third index of refraction (n2);
wherein
n1′<n1, n1′<n2, and said pinch redirects at least a portion of said photons from said first photon propagating material to said second photon propagating material.

2. The waveguide of claim 1, wherein said waveguide is clad in a material having a lower index of refraction than n1.

3. The waveguide of claim 2, wherein said waveguide is clad in glass.

4. The waveguide of claim 1, wherein said pinch is a squared pinch.

5. The waveguide of claim 1, wherein said pinch is a curved pinch.

6. The waveguide of claim 1, wherein said pinch is an angled pinch.

7. The waveguide of claim 1, wherein said pinch is an irregular pinch.

8. The waveguide of claim 1, wherein said pinch is an offset pinch.

9. The waveguide of claim 1, wherein said pinch is a one-sided pinch.

10. The waveguide of claim 1, further comprising at least one other pinch.

11. The waveguide of claim 1, wherein said pinch allows photons to pass said pinch and propagate in the waveguide at a level that is at or below a threshold amount required to stimulate a laser to lase.

12. An optical apparatus, comprising:
a first photon propagating material having a first index of refraction (n1) and having a pinch disposed therein, said pinch having a second index of refraction (n1′); and
a second photon propagating material disposed in optical communication with said first photon propagating material and said second photon propagating material having a target region disposed therein and said target region having a third index of refraction (n2); wherein
n1′<n1, n1′<n2, and said pinch redirects at least a portion of said photons from said first photon propagating material to said second photon propagating material in at least said target region.

13. The optical apparatus of claim 12, wherein said target region is an active layer.

14. The optical apparatus of claim 12, wherein said target region contains a photodiode.

15. The optical apparatus of claim 12, wherein said waveguide is clad in a material having a lower index of refraction than n1.

16. The optical apparatus of claim 15, wherein said waveguide is clad in glass.

17. The optical apparatus of claim 12, wherein said pinch is a squared pinch.

18. The optical apparatus of claim 12, wherein said pinch is a curved pinch.

19. The optical apparatus of claim 12, wherein said pinch is an angled pinch.

20. The optical apparatus of claim 12, wherein said pinch is an irregular pinch.

21. The optical apparatus of claim 12, wherein said pinch is an offset pinch.

22. The optical apparatus of claim 12, wherein said pinch is a one-sided pinch.

23. The optical apparatus of claim 12, further comprising at least one other pinch.

24. The optical apparatus of claim 12, wherein said pinch allows photons to pass said pinch in an axial direction and propagate in said waveguide at a level that is at or below a threshold amount required to stimulate a laser to lase.

25. An optical apparatus, comprising:
a first photon propagating material having a first index of refraction (n1) and having a pinch disposed therein, said pinch having a second index of refraction (n1′);
a second photon propagating material disposed in direct contact with said first photon propagating material and said second photon propagating material having a target region disposed therein and said target region having a third index of refraction (n2); and
a photon source for supplying photons to said first photon propagating material; wherein
n1′<n1, n1′<n2, and said pinch redirects at least a portion of said photons from said first photon propagating material to said second photon propagating material in at least said target region.

26. The optical apparatus of claim 25, wherein said target region is an active layer.

27. The optical apparatus of claim 25, wherein said target region contains a photodiode.

28. The optical apparatus of claim 25, wherein said waveguide is clad in a material having a lower index of refraction than n1.

29. The optical apparatus of claim 28, wherein said waveguide is clad in glass.

30. The optical apparatus of claim 25, wherein said pinch is a squared pinch.

31. The optical apparatus of claim 25, wherein said pinch is a curved pinch.

32. The optical apparatus of claim 25, wherein said pinch is an angled pinch.

33. The optical apparatus of claim 25, wherein said pinch is an irregular pinch.

34. The optical apparatus of claim 25, wherein said pinch is an offset pinch.

35. The optical apparatus of claim 25, wherein said pinch is a one-sided pinch.

36. The optical apparatus of claim 25, further comprising at least one other pinch.

37. The optical apparatus of claim 25, wherein said pinch allows photons to pass said pinch in an axial direction and propagate in said waveguide at a level that is at or below a threshold amount required to stimulate a laser to lase.

38. A waveguide, comprising:
a first photon propagating material having a first index of refraction (n1) and having a first pinch disposed therein, said pinch having a second index of refraction (n1′); and
a second photon propagating material disposed in direct contact with said first photon propagating material and having a third index of refraction (n2), said second photon propagating material having a second pinch oriented opposite that of said first pinch in an axial direction; wherein
n1′<n1, n1′<n2, and said first and second pinches redirect at least a portion of said photons from said first photon propagating material to said second photon propagating material.

39. The waveguide of claim 38, wherein said waveguide is clad in a material having a lower index of refraction than n1.

40. The waveguide of claim 39, wherein said waveguide is clad in glass.

41. The waveguide of claim 38, wherein said pinch is a squared pinch.

42. The waveguide of claim 38, wherein said pinch is a curved pinch.

43. The waveguide of claim 38, wherein said pinch is an angled pinch.

44. The waveguide of claim 38, wherein said pinch is an irregular pinch.

45. The waveguide of claim 38, wherein said pinch is an offset pinch.

46. The waveguide of claim 38, wherein said pinch is a one-sided pinch.

47. The waveguide of claim 38, further comprising at least one other pinch disposed in said first photon propagating material and axial to said first pinch.

48. The waveguide of claim 38, wherein said first pinch allows photons to pass said first pinch in an axial direction and propagate in said waveguide at a level that is at or below a threshold amount required to stimulate a laser to lase.
